(19) United States
(12) Patent Application Publication
(10) Pub. No.: US 2024/0085201 A1
(43) Pub. Date: Mar. 14, 2024

(54) SERVER, INFORMATION PROCESSING METHOD, AND TERMINAL

(71) Applicant: TOYOTA JIDOSHA KABUSHIKI KAISHA, Toyota-shi (JP)

(72) Inventor: Taiki NAKAMURA, Kariya-shi (JP)

(73) Assignee: TOYOTA JIDOSHA KABUSHIKI KAISHA, Toyota-shi (JP)

(21) Appl. No.: 18/462,705

(22) Filed: Sep. 7, 2023

(30) Foreign Application Priority Data
Sep. 9, 2022 (JP) 2022-143402

(51) Int. Cl. G01C 21/34; G01C 21/36

(52) U.S. Cl. CPC G01C 21/3461; G01C 21/362; G01C 21/367; G01C 21/3685

(57) ABSTRACT

A server has a controller. The controller obtains first information that identifies a facility that is the destination of a user's travel by a vehicle. The controller obtains second information related to the location of an entrance of the facility for vehicles based on the first information it has obtained. The controller transmits a first command to set a route to the facility according to the second information to a first terminal associated with the user.

### CROSS REFERENCE TO THE RELATED APPLICATION

This application claims the benefit of Japanese Patent Application No. 2022-143402, filed on Sep. 9, 2022, which is hereby incorporated by reference herein in its entirety.

### BACKGROUND

### Technical Field

The present disclosure relates to a server, an information processing method, and a terminal.

### Description of the Related Art

It is known in the art to transmit destination information that is searched for on a terminal used by a user to a navigation system provided on a vehicle via a server (see, for example, Patent Literature 1 in the citation list below).

### CITATION LIST

### Patent Literature

Patent Literature 1: Japanese Patent Application Laid-Open No. 2015-049172.

### SUMMARY

An object of this disclosure is to provide a technology that can improve the convenience for users who use a route guidance service for vehicles.

In one aspect of the present disclosure, there is provided a server. In an exemplary mode, the server may include a controller including at least one processor configured to execute the processing of:
obtaining first information that identifies a facility that is the destination of a user's travel by a vehicle;
obtaining second information related to the location of an entrance of the facility for vehicles based on the first information; and
transmitting a first command to set a route to the facility according to the second information to a first terminal associated with the user.

In another aspect of the present disclosure, there is provided an information processing method. In an exemplary mode, the information processing method may include the following processing executed by a computer:
obtaining first information that identifies a facility that is the destination of a user's travel by a vehicle;
obtaining second information related to the location of an entrance of the facility for vehicles based on the first information; and
transmitting a first command to set a route to the facility according to the second information to a first terminal associated with the user.

In another aspect of the present disclosure, there is provided a terminal. In an exemplary mode, the terminal may include a controller including at least one processor, the controller being configured to execute the processing of:
obtaining first information that identifies a facility that is the destination of a user's travel by a vehicle;
obtaining second information related to the location of an entrance of the facility for vehicles based on the first information; and
setting a route to the facility according to the second information.

In another aspect of the present disclosure, there is also provided an information processing program configured to cause a computer to implement the above-described information processing method or a computer-readable storage medium storing such an information processing program in a non-transitory manner.

According to the present disclosure, there is provided a technology that can improve the convenience for users who use a route guidance service for vehicles.

### BRIEF DESCRIPTION OF THE DRAWINGS

FIG. 1 is a diagram illustrating the general configuration of a route guidance system according to a first embodiment.

FIG. 2 is a diagram illustrating exemplary hardware configurations of a navigation system, a user's terminal, and a server included in the route guidance system according to the first embodiment.

FIG. 3 is a block diagram illustrating an exemplary software configuration of the server according to the first embodiment.

FIG. 4 illustrates an example of data stored in a facility database according to the first embodiment.

FIG. 5 is a flow chart of a processing routine executed in the server according to the first embodiment when it receives first information.

FIG. 6 is a diagram illustrating exemplary routes given for guidance according to the first embodiment.

FIG. 7 is a diagram illustrating an exemplary configuration of a route guidance system according to a modification of the first embodiment.

FIG. 8 is a diagram illustrating an exemplary configuration of a route guidance system according to a second embodiment.

FIG. 9 is a diagram illustrating an exemplary software configuration of a navigation system according to the second embodiment.

FIG. 10 is a flow chart of a processing routine executed in the navigation system according to the second embodiment when it receives the first information.

### DESCRIPTION OF THE EMBODIMENTS

In recent years, a service has become popular in which location information (e.g. geographic coordinates) of a facility searched for on a user's terminal such as a smartphone or a tablet terminal is transmitted from the user's terminal to a navigation system provided in a vehicle, and the navigation system provides route guidance based on the transmitted location information.

Another service has also become popular in which location information of a facility searched for by a search application program on a user's terminal is shared with a route guidance application program on the user's terminal, and the route guidance application program provides route guidance on the user's terminal based on the location information.

The location information used in the search application program on the user's terminal is information used to display the location of the facility on a map, and this information does not necessarily indicate the entrance of the facility for vehicles (e.g. the entrance of the parking lot of the facility). If the location indicated by such location information is selected as the destination in the route guidance, there is a possibility that the user cannot drive the vehicle into the parking lot of the facility quickly, even though he or she can arrive in the vicinity of the facility. This may reduce the convenience for the user.

According to one aspect of the present disclosure, a controller of a server is configured to obtain information (or first information) that identifies a facility that is the destination of a user's travel (or movement) by a vehicle. For example, the first information is the name of the facility, location information of the facility, the telephone number of the facility, or the map code of the facility. The controller of the server may obtain the first information by communication between the server and a user's terminal (e.g. a smartphone or a tablet terminal) through a network. Alternatively, the controller of the server may obtain the first information by communication between the server and a navigation system provided in the user's vehicle through a network.

The controller of the server according to the present disclosure obtains second information based on the first information it has obtained. The second information is information about the position of the entrance for vehicles to the facility that is the destination of the user. The controller of the server may obtain the second information using a database that the server has. This database may store information that identifies the facility and information that indicates the position of the entrance of the facility for vehicles in a linked manner. Then, the controller of the server can access the database using the first information (i.e. the information that identifies the facility) as an argument to obtain the information that indicates the position of the entrance of the facility for vehicles. In this case, the information that indicates the position of the entrance of the facility for vehicles corresponds to the second information.

The controller of the server according to the present disclosure is configured to transmit a first command to set a route to the facility according to the second information to a first terminal associated with the user. The first terminal is a terminal that provides route guidance to the user. For example, the first terminal may be a navigation system provided in the user's vehicle or a user's terminal in which an application program for route guidance is installed. In the case where the navigation system does not have the function of directly communicating with the server, the controller of the server may transmit the first command mentioned above to the navigation system via a user's terminal. Thus, the first terminal can set a route according to the second information. In other words, the first terminal can create a route whose destination location is set at the entrance of the facility for vehicles. In consequence, it is possible to present a route that allows the vehicle to enter the site of the facility quickly to the user as guidance.

The database of the server according to the present disclosure may configured to store the information that identifies the facility, the information that indicates the position of the entrance of the facility for vehicles, and in addition, information on whether access to the entrance from the opposite lane of the road that faces the entrance is possible in a linked manner. In this case, the second information may also include the information on whether access to the entrance from the opposite lane of the road that faces the entrance is possible in addition to the information that indicates the position of the entrance of the facility for vehicles. In the case where the first command to set a route to the facility according to such second information is transmitted from the server to the first terminal, the first terminal can create such a route whose destination location is set to the entrance of the facility for vehicles and that uses a lane from which the entrance is accessible. Thus, it is possible to present a route that allows the vehicle to enter the parking lot of the facility quickly to the user as guidance with improved reliability.

In another mode of the present disclosure, a controller of a terminal is configured to execute the processing of obtaining first information that identifies a facility that is the destination of a user's travel by a vehicle, obtaining second information about the position of the entrance of the facility for vehicles, and setting a route to the facility based on the second information. In this case also, the advantageous effects of the server described above can be achieved similarly. The terminal mentioned here may be a navigation system provided in the user's vehicle or a user's terminal in which a route guidance application program is installed.

In the following, specific embodiments of the technology disclosed herein will be described with reference to the drawings. The features that will be described in connection with the embodiments are not intended to limit the technical scope of the disclosure only to them, unless otherwise stated.

### First Embodiment

In the following description of the embodiment, a case where the server according to the present disclosure is applied to a system that provides a route guidance service to users who want to travel by vehicle will be described. This system will also be referred to as the “route guidance system” hereinafter.

(General Configuration of Route Guidance System)

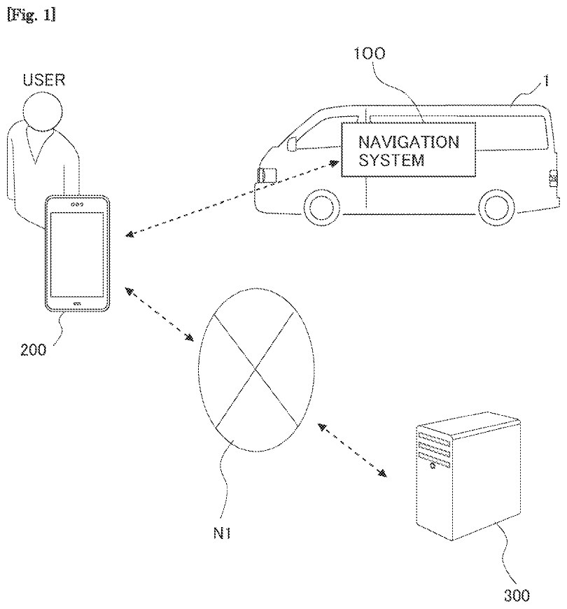

FIG. 1 is a diagram illustrating the general configuration of the route guidance system. The route guidance system illustrated in FIG. 1 includes a navigation system 100, a user's terminal 200, and a server 300. The navigation system 100 is a computer provided in a user's vehicle 1 to provide route guidance to the user. For example, the vehicle 1 is an automobile or a motorcycle that the user uses to travel to a destination. The user's terminal 200 is a small computer used by the user to search for a facility that is the destination of the user's travel by the vehicle 1. The server 30 is a computer installed somewhere outside the vehicle 1. While FIG. 1 illustrates only one navigation system 100 (or vehicle 1) and only one user's terminal 200, the route guidance system may include a plurality of navigation systems (or vehicles 1) and a plurality of user's terminals 200.

The user's terminal 200 and the server 300 are connected through a network N1. For example, the network N1 is a WAN (Wide Area Network), which is a global public communication network such as the Internet, or other communication network. The user's terminal 200 is connected to the network N1 using wireless communications. Examples of the wireless communications include mobile communications, such as 5G (5th Generation), 6G (6th Generation), and LTE (Long Term Evolution) mobile communications, narrow-band communications, such as DSRC (Dedicated Short Range Communications), and Wi-Fi (registered trademark). The user's terminal 200 and the navigation system 100 are connected by short-range wireless communications based on Bluetooth (registered trademark) Low Energy. Alternatively, the user's terminal 200 and the navigation system 100 may be connected by a cable.

The user's terminal 200 in the route guidance system according to this embodiment transmits first information to the server 300 through the network N1. The first information is information that identifies a facility that is the destination of a user's travel by the vehicle 1. The first information includes at least one of the name of the facility, the indicative coordinates of the facility, the address of the facility, the telephone number of the facility, and the map code of the facility. The term “facility” as used here refers to a commercial facility, such as a shopping mall or a department store, or an amusement facility that has a parking lot. The indicative coordinates mentioned above refer to the geographical coordinates (i.e. latitude and longitude) used by a first application program (described later) to indicate the location of the facility on a map. The indicative coordinates do not necessarily coincide with the geographical coordinates of the entrance of the facility for vehicles (i.e. the entrance of the parking lot).

When the server 300 receives the first information transmitted from the user's terminal 200, the server 300 obtains second information based on the first information. The second information includes information on the geographical coordinates of the entrance of the parking lot of the facility identified by the first information and information on whether access to the entrance of the parking lot from the opposite lane of the road that faces the entrance is possible. The information on whether access to the entrance from the opposite lane of the road that faces the entrance is possible is information indicating whether it is possible for vehicles running on the opposite lane to turn left or right to access the entrance. The opposite lane mentioned here is one of the lanes of the road that faces the entrance of the parking lot of which the direction of travel is opposite to the direction of travel of the lane or lanes closest to the entrance. In other words, the opposite lane is such a lane that in order to access the entrance of the parking lot, vehicles travelling on the opposite lane need to cross the lane or lanes closest to the entrance.

If the road that faces the entrance of the parking lot has a central traffic strip (i.e. a structure, such as a wall, that partitions the lane or lanes closest to the entrance of the parking lot and the opposite lane or lanes), or if it is prohibited by the rules of the road for vehicles travelling on the opposite lane to turn left or right toward the entrance of the parking lot, the access to the entrance of the parking lot from the opposite lane is not possible. In contrast, if the road that faces the entrance of the parking lot does not have a central traffic strip, and it is not prohibited by the rules of the road for vehicles travelling on the opposite lane to turn left or right toward the entrance of the parking lot, the access to the entrance of the parking lot from the opposite lane is possible.

When the server 300 obtains the second information, the server 300 transmits a command (first command) to set a route to the facility according to the second information to the user's terminal 200. When the user's terminal 200 receives the first command transmitted from the server 300, the user's terminal 200 transfers the first command to the navigation system 100. In consequence, the navigation system 100 can set a route to the facility based on the second information. Specifically, the navigation system 100 can set a route to the facility with the destination location set to the entrance of the parking lot of the facility and with the lane to travel set to a lane that allows the vehicle to access the entrance among the lanes of the road that faces the entrance. Thus, the system can present a route that allows the vehicle 1 to quickly enter the parking lot of the facility to the user as guidance.

(Hardware Configuration)

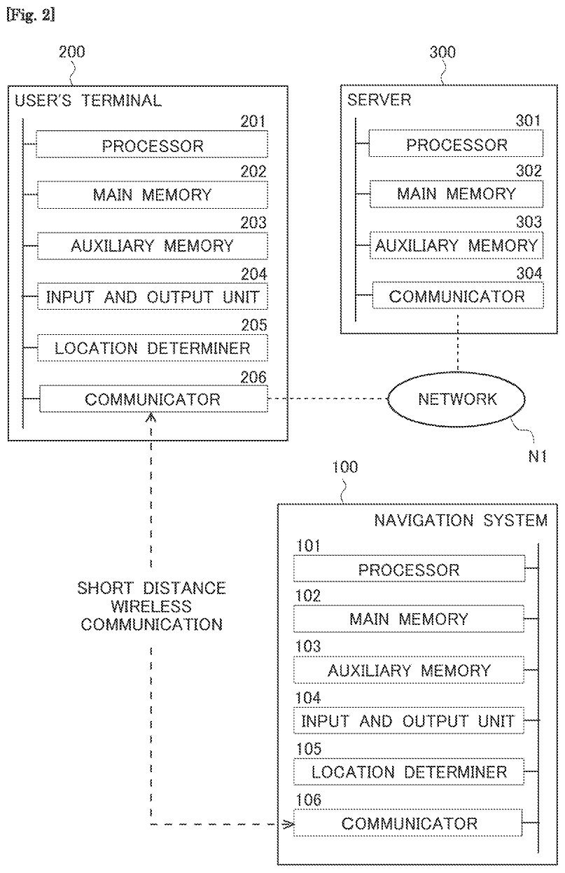

FIG. 2 is a diagram illustrating an example of the hardware configurations of the navigation system 100, the user's terminal 200, and the server 300 included in the route guidance system.

The navigation system 100 is a computer provided in the vehicle 1 used by the user to travel to a facility as the destination. The navigation system 100 is an example of the “first terminal” according to the present disclosure. As illustrated in FIG. 2, the navigation system 100 includes a processor 101, a main memory 102, an auxiliary memory 103, an input and output unit 104, a location determiner 105, and a communicator 106. The processor 101, the main memory 102, the auxiliary memory 103, the input and output unit 104, the location determiner 105, and the communicator 106 are interconnected by buses.

For example, the processor 101 is a CPU (Central Processing Unit) or a DSP (Digital Signal Processor). The processor 101 controls the navigation system 100 by executing computation of various information processing.

The main memory 102 is a computer-readable recording medium. The main memory 102 is a storage device that is used as a recording area into which programs stored in the auxiliary memory 103 are loaded or a buffer in which the results of computation executed by the processor 101 are temporarily stored. For example, the main memory 102 includes a RAM (Random Access Memory) and a ROM (Read Only Memory).

The auxiliary memory 103 is a computer-readable recording medium. The auxiliary memory 103 stores various programs, various data that is used when the programs are executed by the processor 101, and various records. For example, the auxiliary memory 103 includes an EPROM (Erasable Programmable ROM) or an HDD (Hard Disk Drive). The auxiliary memory 103 may include a removable medium or a portable recording medium. Examples of the removable medium include a disc recording medium, such as a CD (Compact Disc) or a DVD (Digital Versatile Disc) or a USB (Universal Serial Bus) memory. The programs stored in the auxiliary memory 103 include a program configured to implement the function of route guidance, besides the operating system (OS). A part or the entirety of the information stored in the auxiliary memory 103 may be stored in the main memory 102 instead.

The input and output unit 104 receives input operations conducted by the user and presents information to the user. For example, the input and output unit 104 includes a touch panel display and a control circuit thereof. The input and output unit 104 according to this embodiment displays the present location of the vehicle 1, the location of the destination facility, and/or a route to the entrance of the parking lot of the destination facility on a map.

The location determiner 105 determines the present location of the navigation system 100 (or the vehicle 1). For example, the location determiner 105 is a GPS (Global Positioning System) receiver. The location determiner 105 is not limited to a GPS receiver. For example, the location determiner 205 may be a wireless communication circuit that uses a location information service based on Wi-Fi (registered trademark) access points. For example, the location information determined by the location determiner 205 is geographical coordinates, such as the latitude and longitude.

The communicator 106 is a communication circuit that communicates with the user's terminal 200 using short-range wireless communication based on Bluetooth (registered trademark) Low Energy or other standard. Alternatively, the communicator 106 may be configured to communicate with the user's terminal 200 through a cable that connects the navigation system 100 and the user's terminal 200.

When the communicator 106 of the navigation system 100 configured as illustrated in FIG. 2 receives the first command transmitted from the server 300 via the user's terminal 200, the processor 101 sets a route to the facility according to the second information. Specifically, the processor 101 sets such a route whose destination location is set at the entrance of the parking lot of the facility and that uses a lane, among the lanes of the road that faces the parking lot of the facility, from which access to the entrance is possible.

The hardware configuration of the navigation system 100 is not limited to the configuration illustrated in FIG. 2, but some components may be added, removed, or replaced by other components fitly. The processing executed in the navigation system 100 may be executed by either hardware or software.

As illustrated in FIG. 2, the user's terminal 200 includes a processor 201, a main memory 202, an auxiliary memory 203, an input and output unit 204, a location determiner 205, and a communicator 206. The processor 201, the main memory 202, the auxiliary memory 203, the input and output unit 204, the location determiner 205, and the communicator 206 are interconnected by buses.

The processor 201, the main memory 202, the auxiliary memory 203, the input and output unit 204, and the location determiner 205 of the user's terminal 200 are similar to the processor 101, the main memory 102, the auxiliary memory 103, the input and output unit 104, and the location determiner 105 of the navigation system 100 and will not be described further.

The programs stored in the auxiliary memory 203 of the user's terminal 200 include first and second application programs, besides the operating system. For example, the first application program is a program configured to implement the function of searching for the facility that is the destination of travel of the user by the vehicle 1 and/or the function of managing the schedule of the travel to the facility set as the destination in the user's terminal 200. The second application program is a program configured to implement the function of sharing the first information with the first application program, the function of transmitting and receiving information related to the route guidance service to and from the server 300, and the function of transmitting and receiving information related to the route guidance service to and from the navigation system 100.

The communicator 206 of the user's terminal 200 includes a circuit to communicate with the navigation system 100 using short-range wireless communication based on Bluetooth (registered trademark) LowEnergy or other standard and a circuit to access the network N1 using mobile communication service (i.e. a telephone communication network such as a mobile phone network or wireless communications, such as Wi-Fi) to communicate with the server 300 through the network N1. Alternatively, the communicator 206 may be configured to communicate with the navigation system 100 through a cable that connects the navigation system 100 and the user's terminal 200.

The user can conduct a search for a facility that is the destination of a user's travel by the vehicle 1 by executing the first application program on the user's terminal 200 configured as illustrated in FIG. 2. When an operation for setting the searched facility as the destination is conducted through the input and output unit 204, the processor 201 executes the second application program to obtain the first information on the facility searched for by the first application program. As described above, the first information is information that identifies the facility searched for by the first application program. The first information includes at least one of the name of the facility, the indicative coordinates of the facility, the address of the facility, the telephone number of the facility, and the map code of the facility. The processor 201 transmits the first information thus obtained to the server 300 by executing the second application program. In doing so, the processor 201 connects the communicator 206 to the network N1 and transmits the first information to the server 300 through the network N1.

When the communicator 206 receives the first command transmitted from the server 300 in response to the first information, the processor 201 of the user's terminal 200 transfers the first command to the navigation system 100. Specifically, the processor 201 transmits the first command from the communicator 206 to the navigation system 100 by short-range wireless communication.

The hardware configuration of the user's terminal 200 is not limited to the configuration illustrated in FIG. 2, but some components may be added, removed, or replaced by other components fitly. The processing executed in the user's terminal 200 may be executed by either hardware or software.

The server 300 is a computer that is run by the provider of the route guidance service. As illustrated in FIG. 2, the server 300 according to the embodiment includes a processor 301, a main memory 302, an auxiliary memory 303, and a communicator 304. The processor 301, the main memory 302, the auxiliary memory 303, and the communicator 304 are interconnected by buses.

The processor 301, the main memory 302, and the auxiliary memory 303 of the server 300 are similar to the processor 101, the main memory 102, and the auxiliary memory 103 of the navigation system 100 and will not be described further.

The programs stored in the auxiliary memory 303 of the server 300 includes a program configured to implement the function of obtaining the first information, the function of obtaining the second information based on the first information, the function of creating the first command based on the second information, and the function of transmitting the first command to the navigation system 100 via the user's terminal 200 in the server 300, besides the operating system.

The communicator 304 connects the server 300 to the network N1. The communicator 304 connects the server 300 to the user's terminal 200 through the network N1. For example, the communicator 304 includes a LAN (local Area Network) interface board or a wireless communication circuit for wireless communication.

The hardware configuration of the server 300 is not limited to the configuration illustrated in FIG. 2, but some components may be added, removed, or replaced by other components fitly. The processing executed in the server 300 may be executed by either hardware or software.

(Software Configuration of Server)

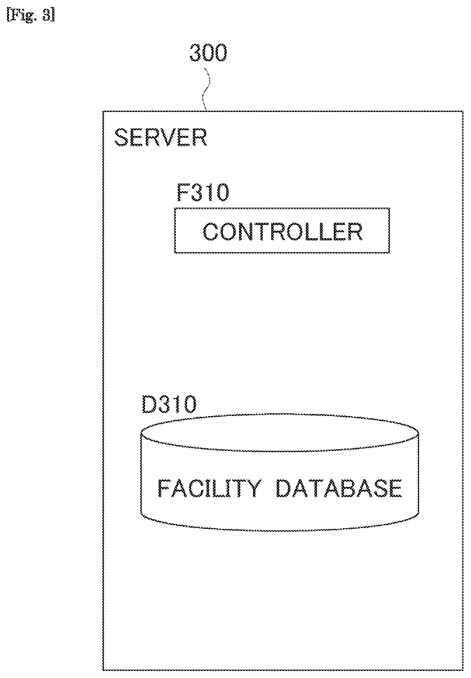

The software configuration of the server 300 according to this embodiment will now be described with reference to FIG. 3. FIG. 3 is a block diagram illustrating an example of the software configuration of the server 300 according to this embodiment. As illustrated in FIG. 3, the server 300 according to this embodiment includes, as software modules, a controller F310 and a facility database D310.

The controller F310 is implemented by the processor 301 of the server 300 by loading a program stored in the auxiliary memory 303 into the main memory 302 and executing it. Alternatively, the controller F310 may be implemented by a hardware circuit, such as an ASIC (Application Specific Integrated Circuit) or an FPGA (Field Programmable Gate Array).

The facility database D310 is constructed by a database management system (DBMS) by managing data stored in the auxiliary memory 303. The database management system is a program executed by the processor 301 of the server 300. For example, the facility database D310 is a relational database.

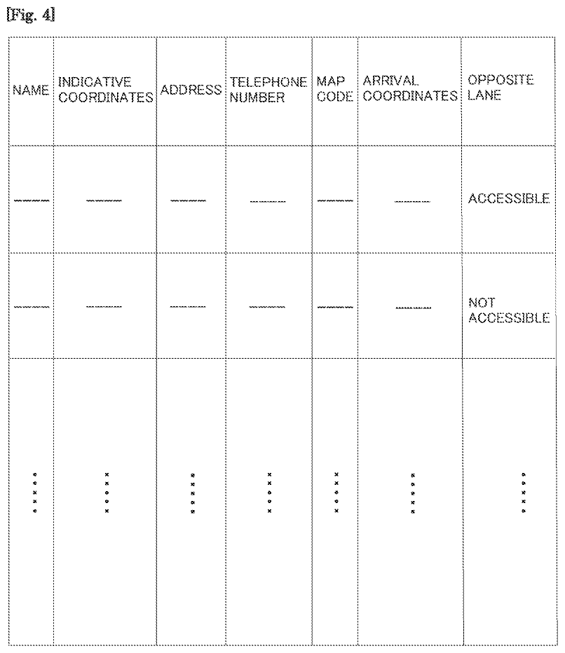

The facility database D310 records data that links the first information and the second information. FIG. 4 illustrates an example of the information stored in the facility database D310. As illustrated in FIG. 4, the facility database D310 according to this embodiment stores records of respective facilities. This record will also be referred to as “facility information record” hereinafter. As illustrated in FIG. 4, each facility information record has the fields of name, indicative coordinates, address, telephone number, map code, arrival coordinates, and opposite lane. The structure of the facility information record is not limited to the example illustrated in FIG. 4, but some fields may be added, changed, or deleted.

What is stored in the name field is information indicating the name of each facility. What is stored in the indicating coordinates field is the indicative coordinates. What is stored in the address field is information indicating the address of each facility. What is stored in the telephone number field is information indicating the telephone number of each facility. What is stored in the map code field is information indicating the map code of each facility. What is stored in the arrival coordinates field is the arrival coordinates of each facility. The “arrival coordinates” are the geographical coordinates (i.e. the latitude and longitude) of the entrance of the parking lot of each facility. What is stored in the opposite lane field is information indicating whether access to the entrance of the parking lot of each facility from the opposite lane of the road that faces the entrance is possible. The information stored in the opposite lane field will also be referred to as “accessibility information” hereinafter. In the case of the facilities of which the road that faces the entrance of the parking lot of the facility does not have a central traffic strip, and turning right or left toward the entrance of the parking lot from the opposite lane of the road that faces the entrance is not prohibited by the rules of the road, the information “accessible” is recorded in the opposite lane field. In the case of the facilities of which the road that faces the entrance of the parking lot of the facility has a central traffic strip, or turning right or left toward the entrance of the parking lot from the opposite lane of the road that faces the entrance is prohibited by the rules of the road, the information “not accessible” is recorded in the opposite lane field.

Referring back to FIG. 3, the controller F310 obtains the first information transmitted from the user's terminal 200 to the server 300. Specifically, when the communicator 304 receives the first information transmitted from the user's terminal 200 to the server 300, the communicator 304 transfers the first information to the processor 301, and thus the controller F310 obtains the first information.

The controller F310 accesses the facility database D310 using the first information it obtained as an argument to retrieve the second information related to the facility identified by the first information. The first information is information that includes at least one of the name of the facility, the indicative coordinates of the facility, the address of the facility, the telephone number of the facility, and the map code of the facility. The second information is information that includes the geographical coordinates (arrival coordinates) of the entrance of the parking lot of the facility that is identified by the first information and information (accessibility information) on whether access to the entrance of the parking lot from the opposite lane of the road that faces the entrance is possible. The controller F310 accesses the facility database D310 using the first information as an argument to find the facility information record in which information identical to the first information is stored in its name field, indicative coordinates field, address field, telephone number field, or map code field. The controller F310 reads out the information stored in the arrival coordinates field of the facility information record thus found (i.e. the arrival coordinates) and the information stored in the opposite lane field of the facility information record thus found (i.e. the accessibility information).

The controller F310 creates a first command based on the second information (i.e. the arrival coordinates and the accessibility information) read out from the facility database D310. The first command is a command to set a route to the facility according to the second information. Specifically, the first command is a command to create such a route whose destination location is set at the location of the geographical coordinates of the entrance of the parking lot of the facility (i.e. the arrival coordinates) and that uses a lane, among the lanes of the road that faces the entrance of the parking lot of the facility, from which access to the entrance is possible. The controller F310 transmits the first command thus created to the navigation system 100 via the user's terminal 200. If the navigation system 100 has a communication circuit that can access the network N1 using a mobile communications service, the controller F310 may transmit the first command directly to the navigation system 100.

One or some of the software modules of the server 300 and/or a portion of the processing executed by them may be implemented or executed by an external computer that is connected to the network N1. For example, among the pieces of processing executed by the controller F310, the processing of creating the first command based on the second information may be executed by the user's terminal 200. In this case, the controller F310 of the server 300 may transmit the second information read out from the facility database D310 to the user's terminal 200. Then, the processor 201 of the user's terminal 200 may create the first command based on the second information received from the server 300 and transmits the created first command to the navigation system 100. The software configuration of the server 300 is not limited to the configuration illustrated in FIG. 3, but some components may be removed, changed, or added.

(Process Executed in Server)

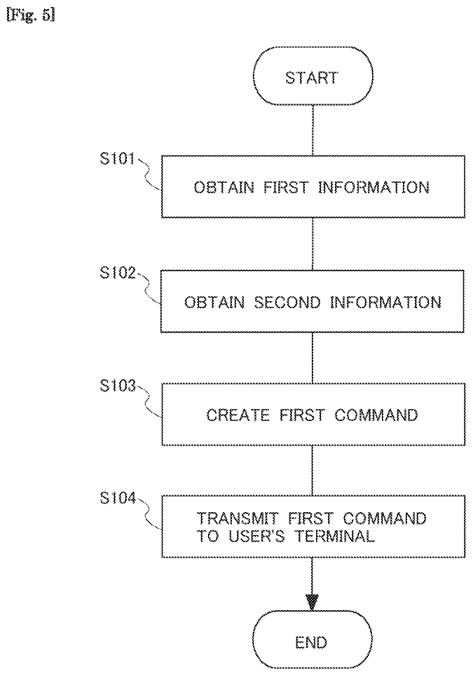

A process executed in the server 300 will now be described with reference to FIG. 5. FIG. 5 is a flow chart of a processing routine executed in the server 300, which is triggered by the reception of the first information transmitted from the user's terminal 200. While the processing routine according to the flow chart of FIG. 5 is executed by the processor 301 of the server 300, software modules of the server 300 will be mentioned in the following description as the components that execute the processing in the routine.

In the processing routine according to the flow chart of FIG. 5, when the communicator 304 of the server 300 receives the first information transmitted from the user's terminal 200, the controller F310 receives the first information from the communicator 304 (step S101). After completing the processing of step S101, the controller F310 executes the processing of step S102 next.

In step S102, the controller F310 obtains the second information. Specifically, the controller F310 accesses the facility database D310 using the first information as an argument to find the facility information record in which information identical to the first information is stored in its name field, indicative coordinates field, address field, telephone number field, or map code field. The controller F310 reads out the information stored in the arrival coordinates field of the facility information record thus found (i.e. the arrival coordinates) and the information stored in the opposite lane field of the facility information thus found (i.e. the accessibility information) as second information. After completing the processing of step S102, the controller F310 executes the processing of step S103 next.

In step S103, the controller F310 creates the first command. The first command is a command to set a route to the facility according to the second information retrieved in step S102. After completing the processing of step S103, the controller F310 executes the processing of step S104 next.

In step S104, the controller F310 transmits the first command created in step S103 to the user's terminal 200 through the communicator 304. After completing the processing of step S104, the controller F310 finishes executing this processing routine.

### Operation and Advantageous Effects of System According to First Embodiment

According to the first embodiment, when a facility is searched for with the first application program on the user's terminal 200, and an operation for setting the facility as the destination is conducted on the user's terminal 200, the first information related to that facility is obtained and transmitted to the server 300 by the second application program. Then, the server 300 executes the above-described processing routine according to the flow chart of FIG. 5 to create the first command, and the first command is transmitted to the navigation system 100 via the user's terminal 200. In consequence, the navigation system 100 can operate according to the first command.

The first command according to this embodiment is a command to set a route to the facility according to the second information. The second information includes the geographical coordinates of the entrance of the parking lot of the facility (i.e. the arrival coordinates) and information on whether access to the entrance of the parking lot of the facility from the opposite lane of the road that faces the entrance is physically possible and allowed by the rules of the road (i.e. the accessibility information). After receiving this first command, the navigation system 100 searches for such a route whose destination location is set at the entrance of the parking lot of the facility and that uses a lane, among the lanes of the road that faces the entrance, from which access to the entrance is possible and sets it as the route to the facility.

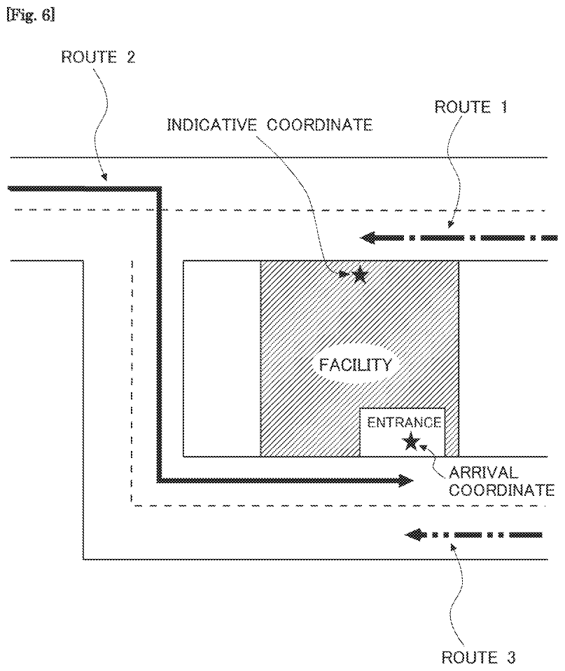

FIG. 6 is a diagram illustrating examples of the route set by the navigation system 100 according to the embodiment. Route 1 represented by the dot-dash line in FIG. 6 is a route whose destination location is set at indicative coordinates that indicate a location different from the entrance of the parking lot of the facility, which is illustrated for information. Route 2 represented by the dot-dot-dash line in FIG. 6 is a route whose destination location is set at the arrival coordinates of the facility (i.e. the geographical coordinates of the entrance of the parking lot of the facility) and that accesses the entrance of the parking lot of the facility from the opposite lane of the road that faces the entrance. Route 3 represented by the solid line in FIG. 6 is a route whose destination location is set at the arrival coordinates of the facility and that accesses the entrance of the parking lot of the facility from the lane, among the lanes of the road that faces the entrance, that is adjacent to the entrance (i.e. the lane whose direction of traffic is opposite to that of the opposite lane).

If a route like route 1 illustrated in FIG. 6 whose destination location is set at the indicative coordinates indicating a location difference from the entrance of the parking lot of the facility is set, even though the user can arrive at a location from which he or she can see the facility, there is a possibility that he or she cannot immediately find the location of the entrance of the parking lot and cannot drive the vehicle 1 into the parking lot quickly.

The navigation system 100 according to the embodiment can set a route like route 2 or 3 illustrated in FIG. 6 whose destination location is set at the arrival coordinates of the facility. In consequence, the user can drive the vehicle 1 along route 2 or 3 to reach a location where he or she can see the entrance of the parking lot of the facility. Consequently, the user can drive the vehicle 1 into the parking lot quickly.

According to the embodiment, if access to the entrance of the parking lot of the facility from the opposite lane of the road that faces the entrance is not possible, the navigation system 100 can set a route like route 2 illustrated in FIG. 6 that accesses the entrance of the parking lot using the lane closest to the entrance among the lanes of the road that faces the entrance. In other words, if access to the entrance of the parking lot of the facility from the opposite lane of the road that faces the entrance is not possible, the navigation system 100 can exclude a route like route 3 illustrated in FIG. 6 that accesses the entrance of the parking lot from the opposite lane of the road that faces the entrance, when setting a route. In consequence, even if access to the entrance of the parking lot of the facility from the opposite lane of the road that faces the entrance is not possible, the user can drive the vehicle 1 into the parking lot quickly.

As above, the system according to the embodiment can improve the convenience for users who use a route guidance service for vehicles.

### Modification of the First Embodiment

In the system according to the above-described first embodiment, the navigation system 100 provided in the vehicle 1 sets a route to the facility according to the first command. Alternatively, the user's terminal 200 may set a route to the facility according to the first command.

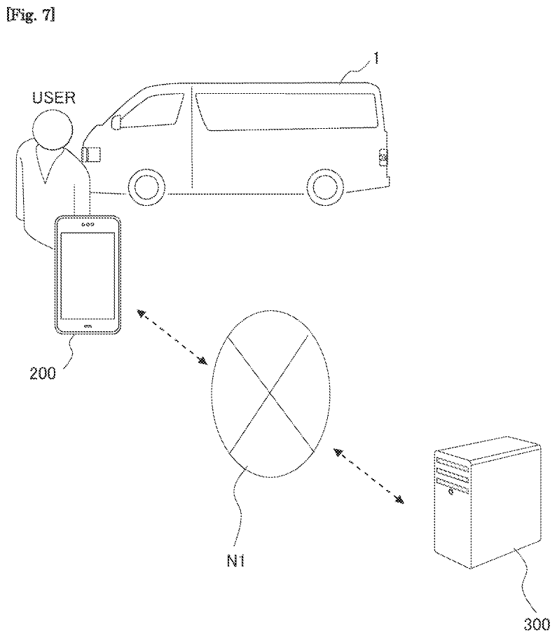

FIG. 7 is a diagram illustrating an exemplary configuration of a route guidance system according to a modification of the first embodiment. The route guidance system of this modification includes a user's terminal 200 and a server 300. The hardware configuration and the software configuration of the server 300 are the same as those according to the first embodiment. The user's terminal 200 according to the modification has an application program installed in it to implement the route guidance function for vehicles (which will also be referred to as the third application program hereinafter) in the user's terminal 200 in addition to the first and the second application programs.

In the route guidance system according to this modification, when the user's terminal 200 receives the first command transmitted from the server 300, the processor 201 of the user's terminal 200 executes the third application program to set a route according to the first command. Thus, the operation and the advantageous effects same as those of the first embodiment described above can be achieved. In the case of this modification, the user's terminal 200 corresponds to the “first terminal” according to the present disclosure.

### Second Embodiment

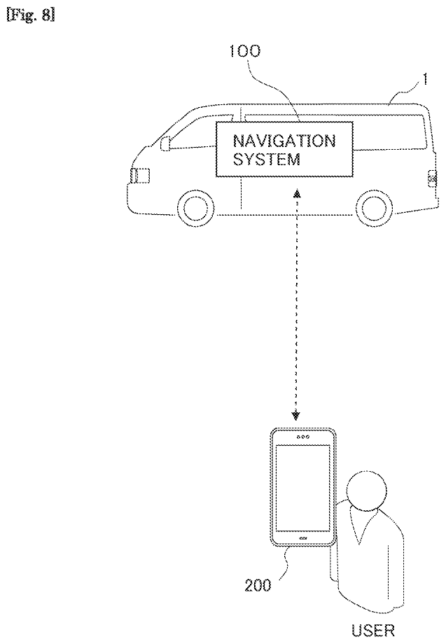

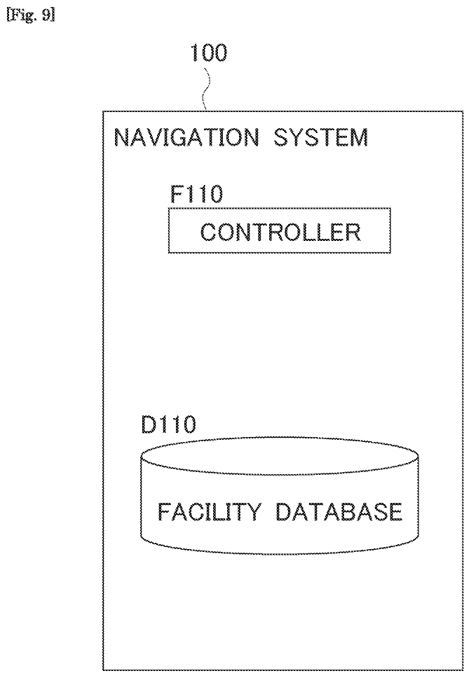

A second embodiment of the technology disclosed herein will be described next with reference to FIGS. 8 and 9. In the following description of the second embodiment, a case where the terminal according to the present disclosure is applied to a route guidance system will be described.

(General Configuration of Route Guidance System)

FIG. 8 is a diagram illustrating the general configuration of a route guidance system according to the second embodiment. The route guidance system illustrated in FIG. 8 includes a navigation system 100 provided in a vehicle 1 and a user's terminal 200 used by the user of the vehicle 1. The navigation system 100 and the user's terminal 200 are connected by short-range wireless communication. Alternatively, the navigation system 100 and the user's terminal 200 may be connected by a cable to communicate with each other.

The user's terminal 200 in the route guidance system according to the second embodiment is configured to transmit first information to the navigation system 100 by short-range wireless communication. The first information according to the second embodiment is the same as the first information according to the above-described first embodiment. When the navigation system 100 receives the first information transmitted from the user's terminal 200, the navigation system 100 obtains second information about the facility identified by the first information. The second information according to the second embodiment is the same as the second information according to the above-described first embodiment. In the route guidance system according to the second embodiment, the navigation system 100 sets a route to the facility according to the second information. Specifically, the route to the facility set by the navigation system 100 is such a route whose destination location is set at the entrance of the parking lot of the facility and that uses a lane from which access to the entrance is possible among the lanes of the road that faces the entrance.

The hardware configurations of the navigation system 100 and the user's terminal 200 are the same as those in the system according to the first embodiment described above and will not be described further.

(Software Configuration of Navigation System)

The software configuration of the navigation system 100 will be described with reference to FIG. 9. FIG. 9 is a block diagram illustrating an example of the software configuration of the navigation system 100 according to this embodiment. As illustrated in FIG. 9, the navigation system 100 according to this embodiment includes, as software modules, a controller F110 and a facility database D110.

The controller F110 is implemented by the processor 101 of the navigation system 100 by loading a program stored in the auxiliary memory 103 into the main memory 102 and executing it. Alternatively, the controller F110 may be implemented by a hardware circuit, such as an ASIC (Application Specific Integrated Circuit) or an FPGA (Field Programmable Gate Array).

The facility database D110 is constructed by a database management system (DBMS) by managing data stored in the auxiliary memory 103. The database management system is a program executed by the processor 101 of the navigation system 100. For example, the facility database D110 is a relational database, similarly to the facility database D310 in the server 300 according to the first embodiment described above.

One or some of the software modules of the navigation system 100 and/or a portion of the processing executed by them may be implemented or executed by an external computer that is connected to the network N1. The software configuration of the navigation system 100 is not limited to the configuration illustrated in FIG. 9, but some components may be removed, changed, or added.

The facility database D110 records data that links the first information and the second information. The information stored in the facility database D110 is the same as the information stored in the facility database D310 in the server 300 according to the first embodiment described above and will not be described further.

The controller F110 obtains the first information transmitted from the user's terminal 200 to the navigation system 100. Specifically, when the communicator 106 receives the first information transmitted from the user's terminal 200 to the navigation system 100, the communicator 106 transfers the first information to the processor 101, and thus the controller F110 obtains the first information.

The controller F110 accesses the facility database D110 using the first information it obtained as an argument to retrieve the second information related to the facility identified by the first information. The controller F110 finds the facility information record in which information identical to the first information is stored in its name field, indicative coordinates field, address field, telephone number field, or map code field. The controller F110 reads out the information stored in the arrival coordinates field of the facility information record thus found (i.e. the arrival coordinates) and the information stored in the opposite lane field of the facility information record thus found (i.e. the accessibility information).

The controller F110 sets a route to the facility based on the second information (i.e. the arrival coordinates and the accessibility information) read out from the facility database D110. Specifically, the controller F110 searches for such a route whose destination location is set at the geographical coordinates of the entrance of the parking lot of the facility (i.e. the arrival coordinates) and that uses a lane, among the lanes of the road that faces the entrance, from which access to the entrance is possible. The controller F110 sets the route found by the search as the route to the facility.

(Process Executed in Navigation System)

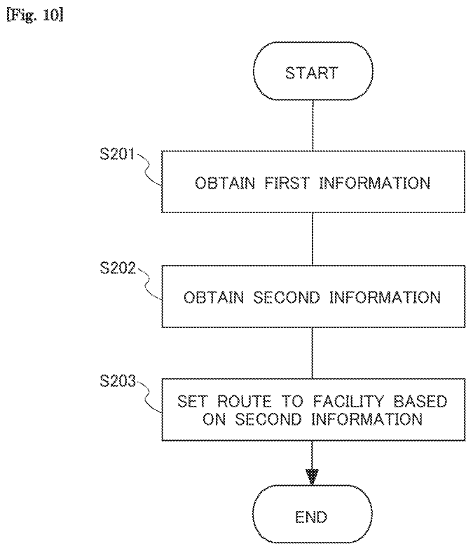

A process executed in the navigation system 100 will now be described with reference to FIG. 10. FIG. 10 is a flow chart of a processing routine executed in the navigation system 100, which is triggered by the reception of the first information transmitted from the user's terminal 200. While the processing routine according to the flow chart of FIG. 10 is executed by the processor 101 of the navigation system 100, software modules of the navigation system 100 will be mentioned in the following description as the components that execute the processing in the routine.

In the processing routine according to the flow chart of FIG. 10, when the communicator 106 of the navigation system 100 receives the first information transmitted from the user's terminal 200, the controller F110 obtains or receives the first information from the communicator 106 (step S201). After completing the processing of step S201, the controller F110 executes the processing of step S202 next.

In step S202, the controller F110 obtains the second information. Specifically, the controller F110 accesses the facility database D110 using the first information as an argument to find the facility information record in which information identical to the first information is stored in its name field, indicative coordinates field, address field, telephone number field, or map code field. The controller F110 reads out the information stored in the arrival coordinates field of the facility information record thus found (i.e. the arrival coordinates) and the information stored in the opposite lane field of the facility information thus found (i.e. the accessibility information) as second information. After completing the processing of step S202, the controller F110 executes the processing of step S203 next.

In step S203, the controller F110 sets a route to the facility based on the second information. Specifically, the controller F110 searches for such a route whose destination location is set at the geographical coordinates of the entrance of the parking lot of the facility (i.e. the arrival coordinates) and that uses a lane, among the lanes of the road that faces the entrance, from which access to the entrance is possible. Then, the controller F110 sets the route found by the search as the route to the facility. After completing the processing of step S203, the controller F110 finishes executing this processing routine.

### Operation and Advantageous Effects of System According to Second Embodiment

According to the second embodiment, when a facility is searched for with the first application program on the user's terminal, and an operation for setting the facility as the destination is conducted on the user's terminal 200, the first information that identifies that facility is transmitted to the navigation system 100 by the second application program. Then, the navigation system 100 executes the above-described processing routine according to the flow chart of FIG. 10 to set a route according to the second information. Specifically, the navigation system 100 searches for such a route whose destination location is set at the entrance of the parking lot of the facility and that uses a lane, among the lanes of the road that faces the entrance, from which access to the entrance is possible and sets the route found by the search as the route to the facility. In consequence, the user can drive vehicle 1 along the route set by the navigation system 100 to bring the vehicle 1 quickly into the parking lot of the facility.

According to the second embodiment, if access to the entrance of the parking lot of the facility from the opposite lane of the road that faces the entrance is not possible, the navigation system 100 can set a route like the aforementioned route 2 illustrated in FIG. 6 that accesses the entrance of the parking lot using the lane closest to the entrance among the lanes of the road that faces the entrance as the route to the facility. In consequence, even if access to the entrance of the parking lot of the facility from the opposite lane of the road that faces the entrance is not possible, the user can drive the vehicle 1 into the parking lot quickly.

As above, the system according to the embodiment can improve the convenience for users who use a route guidance service for vehicles. The navigation system 100 according to the second embodiment corresponds to the “terminal” according to the present disclosure.

### Modification of Second Embodiment

While the navigation system 100 in the system according to the second embodiment has the facility database D110, one or some of the software modules of the navigation system 100 or a portion of the processing executed by them may be implemented or executed by an external computer connected to the navigation system 100 via a network. For example, the facility database D110 may be constructed in an external computer. In that case, the controller F110 of the navigation system 100 may transmit the first information received from the user's terminal 200 to the external computer and receive the second information from the external computer in return.

### <Others>

The above embodiments have been described only by way of example. The technology disclosed herein can be implemented in modified manners without departing from the essence of this disclosure.

The processing and features described in this disclosure may be employed in any combination, so long as it is technically feasible to do so. The hardware configuration employed to implement various functions in a computer system may be modified flexibly.

The technology disclosed herein can be implemented by supplying a computer program (or information processing program) or program that implement the functions described in the above description of the embodiment to a computer to cause one or more processors of the computer to read out and execute the program or programs. The computer may be a server or a user's terminal. Such a computer program or programs may be supplied to the computer by a non-transitory, computer-readable storage medium that can be connected to a system bus of the computer or through a network. The non-transitory, computer-readable storage medium is a recording medium that can store information such as data and programs electrically, magnetically, optically, mechanically, or chemically in a computer-readable manner. Examples of such a recording medium include any type of discs including magnetic discs, such as a floppy disc (registered trademark) and a hard disk drive (HDD), and optical discs, such as a CD-ROM, a DVD, and a Blu-ray disc. The non-transitory, computer-readable storage medium may also be a read-only memory (ROM), a random access memory (RAM), an EPROM, an EEPROM, a magnetic card, a flash memory, an optical card, a solid state drive (SSD), or other medium.

What is claimed is:

1. A server comprising a controller including at least one processor, the controller being configured to execute the processing of:
obtaining first information that identifies a facility that is the destination of a user's travel by a vehicle;
obtaining second information related to the location of an entrance of the facility for vehicles based on the first information; and
transmitting a first command to set a route to the facility according to the second information to a first terminal associated with the user.

2. The server according to claim 1, wherein the second information includes information that indicates the location of the entrance.

3. The server according to claim 2, wherein the second information further includes information on whether access to the entrance from an opposite lane of the road that faces the entrance is possible or not.

4. The server according to claim 3, further comprising a database that stores information that identifies the facility, the information that indicates the location of the entrance, and the information on whether access to the entrance from an opposite lane of the road that faces the entrance is possible or not in a linked manner, wherein the controller obtains the second information based on the first information and the information stored in the database.

5. The server according to claim 4, wherein the information that identifies the facility includes the name of the facility, location information of the facility, the address of the facility, the telephone number of the facility and the map code of the facility, and the first information includes at least one of the name of the facility, the location information of the facility, the address of the facility, the telephone number of the facility, and the map code of the facility.

6. The server according to claim 5, wherein the first terminal is a terminal carried by the user, and the controller obtains the first information by communicating with the first terminal through a network.

7. The server according to claim 5, wherein the first terminal is a navigation system provided in the vehicle, and the controller obtains the first information by communicating with the first terminal through a network.

8. An information processing method comprising the following processing executed by a computer:
obtaining first information that identifies a facility that is the destination of a user's travel by a vehicle;
obtaining second information related to the location of an entrance of the facility for vehicles based on the first information; and
transmitting a first command to set a route to the facility according to the second information to a first terminal associated with the user.

9. The information processing method according to claim 8, wherein the second information includes information that indicates the location of the entrance.

10. The information processing method according to claim 9, wherein the second information further includes information on whether access to the entrance from an opposite lane of the road that faces the entrance is possible or not.

11. The information processing method according to claim 10, wherein the computer has a database that stores information that identifies the facility, the information that indicates the location of the entrance, and the information on whether access to the entrance from an opposite lane of the road that faces the entrance is possible or not in a linked manner, and the computer obtains the second information based on the first information and the information stored in the database.

12. The information processing method according to claim 11, wherein the information that identifies the facility includes the name of the facility, location information of the facility, the address of the facility, the telephone number of the facility and the map code of the facility, and the first information includes at least one of the name of the facility, the location information of the facility, the address of the facility, the telephone number of the facility, and the map code of the facility.

13. The information processing method according to claim 12, wherein the first terminal is a terminal carried by the user, and the computer obtains the first information by communicating with the first terminal through a network.

14. The information processing method according to claim 12, wherein the first terminal is a navigation system provided in the vehicle, and the computer obtains the first information by communicating with the first terminal through a network.

15. A terminal comprising a controller including at least one processor, the controller being configured to execute the processing of:
obtaining first information that identifies a facility that is the destination of a user's travel by a vehicle;
obtaining second information related to the location of an entrance of the facility for vehicles based on the first information; and
setting a route to the facility according to the second information.

16. The terminal according to claim 15, wherein the second information includes information that indicates the location of the entrance.

17. The terminal according to claim 16, wherein the second information further includes information on whether access to the entrance from an opposite lane of the road that faces the entrance is possible or not.

18. The terminal according to claim 17, wherein the controller obtains the second information by executing the processing of transmitting the first information to an external apparatus through a network and receiving the second information from the external apparatus through the network.

19. The terminal according to claim 17, further comprising a database that stores information that identifies the facility, the information that indicates the location of the entrance, and the information on whether access to the entrance from an opposite lane of the road that faces the entrance is possible or not in a linked manner, wherein the controller obtains the second information based on the first information and the information stored in the database.

20. The terminal according to claim 19, wherein the information that identifies the facility includes the name of the facility, location information of the facility, the address of the facility, the telephone number of the facility and the map code of the facility, and the first information includes at least one of the name of the facility, the location information of the facility, the address of the facility, the telephone number of the facility, and the map code of the facility.
